(19) United States
(12) Patent Application Publication
(10) Pub. No.: US 2019/0272701 A1
(43) Pub. Date: Sep. 5, 2019

(54) Lottery Game System and Method with Augmented Reality Component

(71) Applicant: Scientific Games International, Inc., Newark, DE (US)

(72) Inventors: Mohit Mohan, Bangalore (IN); Sandeep Doddipalli, Bangalore (IN)

(21) Appl. No.: 15/910,651

(22) Filed: Mar. 2, 2018

(51) Int. Cl. G07F 17/32

(52) U.S. Cl. CPC G07F 17/329; G07F 17/3211

(57) ABSTRACT

A method for introducing augmented reality components to a lottery game encourages players to visit retail establishments that sell lottery tickets. A game server is configured for communication with mobile devices to implement the augmented reality aspects, the game server receiving real-world location data from the player's mobile device. Via an application running on the player's mobile device, a retail establishment location is identified where the player can purchase a lottery ticket. Via the application, at least one geographic location between the player's actual real-world location and the retail establishment is tagged. Upon the player reaching the tagged location, the game server enables an overlay of a virtual objet on a screen image of the geographic location on the player's mobile device. The player interacts with the virtual object, wherein the interaction causes a code to be downloaded to the mobile device, the code associated with a value. At the retail establishment, the code is activated for the player.

### BACKGROUND

The lottery or gaming industry is continuously seeking methods to enhance the gaming experience for players, as well as to increase the benefit for participating retail establishments that sell lottery tickets.

For many patrons, the purchase of a lottery ticket at retail establishments, such as gas stations and convenience stores, is secondary to another purchase or reason for visiting the retail establishment. For example, a patron may decide as an afterthought to also buy a lottery ticket once they have stopped at a gas station to purchase fuel. Except in the situation where an extraordinarily high jackpot (e.g. a record Powerball™ jackpot) motivates players to visit the retail establishments for the primary purpose of purchasing lottery tickets, the sale of lottery tickets may not be a significant “driver” of patron traffic to the location. As other methods are implemented for purchase of lottery tickets by players electronically via the Internet (or other remote means), the role of the retail establishments will continue to diminish, as well as the motivation for the retail establishments to act as authorized lottery sales agents.

In addition, with increased availability and connectivity to the Internet, players are looking to integrate their lottery gaming experience with network-enabled personal mobile devices, such as a smartphone or PDA (personal data assistant). In this regard, various lottery providers or authorities are now providing electronic game tickets wherein the reveal aspect is conducted via the player's smartphone. For example, the New York Lottery has recently introduced a scratch-off lottery ticket game (“Gold Castle”) wherein the ticket includes a conventional scratch-off game play area and an optional 3-D game reveal capability. Players can download an application to their smartphone that enables a program to scan a code on the ticket and automatically launch the application, which presents a 3-D view of a castle on the player's smartphone. The player taps windows in the castle, which open to reveal whether the player has won a prize or not.

Virtual or augmented reality location-based video games that are played by applications running on smartphones have also grown in popularity, such as the Pokémon Go™ and Ingress™ games from Niantic. These games have introduced new and exciting experiences to players but, to date, have not been successfully introduced into a lottery gaming environment.

The present invention seeks methods to address the issues discussed above with respect to the conventional retail establishments while also enhancing a player's lottery gaming experience via their mobile device.

### SUMMARY

Objects and advantages of the invention will be set forth in part in the following description, or may be obvious from the description, or may be learned through practice of the invention.

In a particular embodiment, the invention provides a method for introducing augmented reality aspects to a lottery game that will encourage players to visit retail establishments that sell lottery tickets. The method includes configuring a game server for communication with player mobile devices to implement the augmented reality aspects, wherein the game server receives real-world location data from the player's mobile device. Via an application running on the player's mobile device, location of a retail establishment is provided where the player can purchase a lottery ticket. Via the application on the player's mobile device, at least one geographic location that lies between the player's actual real-world location and the retail establishment is tagged (e.g. identified). Upon the player reaching the tagged location, the game server enables overlay of a virtual objet on a screen image of the geographic location on the player's mobile device. The application running on the mobile device provides for the player to interact with the virtual object, wherein the interaction causes a code to be downloaded to the mobile device, the code associated with a value to the player. Once the player arrives at the retail establishment, the code is activated and the value is available to the player.

In a particular embodiment of the method, the value of the code is not made known to the player when the code is downloaded, and is revealed to the player at the retail establishment. The method may require that the value of the code is only provided if the player actually purchases a lottery ticket at the retail establishment. In this embodiment, the value of the code may be revealed to the player before they purchase the ticket so as to incentivize the purchase. In another embodiment, the value of the code may not be revealed until after the player purchases the ticket.

The value associated with the codes may vary widely within the scope and spirit of the invention. For example, the value of the code may be a discount or credit for goods or services at the particular retail establishment where the value of the code is revealed. In another embodiment, the value of the code may be a discount or credit for goods or services from a different unrelated retail establishment, such as a restaurant, department store, service provider, and so forth (which includes Internet establishments). In still another embodiment, the value of the code may be an enhancement to a prize award of a lottery ticket purchased at the retail establishment. For example, the code may grant the player a multiplier value for any prize award from a lottery ticket.

The lottery authority responsible for providing the lottery game may implement individual player accounts that can be accessed by the players. The code values may be recorded and accumulate in the player's respective account for later use and/or redemption.

In a particular embodiment, multiple ones of the participating retail establishments are identified to the player via their mobile device within a predefined distance of the player's actual location. The player may then freely choose which of the locations they wish to visit. The retail establishments and the player's actual location may be presented in a map provided on the mobile device. Multiple ones of the tagged locations may also be provided on the map. The tagged locations may be common to all of the retail locations so that the player can acquire a code from any one or more of the tagged locations regardless of the particular retail establishment they choose to visit.

In an alternate embodiment, the tagged locations may be associated with only specific ones of the retail establishments. This may be desirable for driving more patrons to remote (or otherwise less-frequented) retail establishments by, for example, providing more valuable or an increased number of codes for these less-frequented locations. Upon the player selecting a particular one of the retail establishments, in a certain embodiment, the tagged locations that are not associated with the selected retail establishment are removed from the map.

The codes may be downloaded to the player's mobile device in any suitable scannable format, such as a barcode, Q-code, alpha-numeric code, or the like. At the retail establishment, the codes are scanned directly from the mobile device to reveal or grant the code value to the player.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the appended figures, in which:

FIG. 1 depicts an exemplary computer-based system for implementing a location-based augmented reality lottery game according to an exemplary embodiment of the present disclosure;

FIG. 2 depicts a real word geography populated with tagged geographic locations;

FIG. 3 depicts another real word geography populated with tagged geographic locations;

FIG. 4 depicts another real word geography populated with tagged geographic locations and a virtual object associated with one of the locations;

FIG. 5 depicts an exemplary screen of player's mobile device with a map for initiating a game play of an augmented reality lottery game according to an exemplary embodiment of the present disclosure;

FIG. 6 depicts an exemplary screen shot of one of the geographic locations with a virtual object overlaid on the screen image;

FIG. 7 depicts an exemplary screen image on the player's mobile device of a code granted to the player for acquiring the virtual object; and

FIG. 8 depicts an exemplary screen image on the player's mobile device that reveals the code values to the player.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

Generally, the present disclosure is directed to a computer-based system and method that introduces augmented reality components and aspects into a player's experience in obtaining lottery tickets. These features will enhance the player's gaming experience, as well as drive increased foot traffic to the retail establishments that are authorized for sale of the lottery tickets. The methodology is player location-based and places the player in an augmented reality (“AR”) world wherein virtual objects are introduced into the player's real world location as they travel between the retail establishments. The player is invited to interact with these virtual objects in order to acquire “rewards” that are granted to the player upon arrival at the retail establishment. As discussed below, the type of reward can vary widely within the scope and spirit of the invention. In addition, the type or presentation of the virtual objects may vary widely and are not a limiting aspect of the invention. For example, in one embodiment, the virtual objects may have a common theme, such as an overall Monopoly™ game theme, wherein the virtual objects are Monopoly game pieces or cards introduced into the player's real word environment, as explained in greater detail below.

In addition, the manner in which the player interacts with the virtual objects may vary widely. For example, the player may be required to capture or collect the virtual objects by taking an action on their mobile device, such as a swipe or tap on the display screen. Depending on how the game is played, the outcome of the player's interactions may be predetermined, wherein the player's actions do not affect the outcome of the action depicted on the screen. Alternately, the actions may be skill-based, wherein the outcome is based on the player's ability direct the outcome on the screen.

In a certain embodiment, a game server hosts the location-based AR aspects wherein virtual objects are introduced into the player's real world geography. Players can navigate to geographic locations (or other specifically defined locations) in the real world where the virtual objects are introduced. In particular, the locations of players in the real world can be monitored or tracked using, for instance, a positioning system (e.g. a GPS system) associated with a player's mobile device. Player location information can be provided to a game server and used to update player locations in the real world.

The virtual objects can be linked with real world landmarks/locations. For instance, the system and method may include various virtual objects associated with landmarks, retail establishments, or other areas of interest in the real world. For instance, as players navigate geographic locations/coordinates in the real world, the players can discover and interact with virtual objects introduced into their real world environment at specific geographic locations, wherein such interaction awards codes or other means that are stored in the player's mobile device, the codes corresponding to a particular value (reward) that is granted to the player upon arrival at the retail establishment.

The location-based augmented reality aspects can be linked to real world commercial activity to encourage or incentivize commercial activity in the real world related to lottery activity. For example, participating retail establishments other than authorized ticket-sale locations can become sponsors in the game, wherein their respective establishment becomes a tagged geographic location in the game where the virtual objects are introduced. The method thus encourages players to also visit these different participating retail establishments during the course of the game. This increased foot traffic in the retail establishments is highly desirable by the retail vendors. In addition, other commercial sponsors, advertisers, businesses, and other entities can become authorized sites in the reality game (e.g. by payment of a sponsorship fee to the lottery authority) where virtual objects are made available to the players.

For instance, entities can attract customers to their real world locations by requesting that virtual objects or other game features be located at a location of commercial activity associated with the entity in the real world. These virtual objects or game features can be designed to be beneficial or necessary to visit to achieve certain game objectives or achievements within the game, such as collecting reward codes as described herein. As a result, sponsors and other entities can attract customers to their real world locations by requesting and arranging for certain virtual objects to be located at particular locations within the parallel reality game.

According to another exemplary embodiment, the AR game aspects can include game features that are linked with data collection activities in the real world. The data collected by the player as a result of performing the data collection activity can be in the form of a photograph, a sound recording, textual information, or other suitable data (e.g. the location of Wi-Fi hotspots, Bluetooth connections, etc.). The collected information can be sent to the game server which can analyze and use the data to improve data associated with the real world aspects of the AR game. For example, a game feature directly linked with data collection activity can include a game objective or task that involves acquiring information about the tagged real world locations where the players acquire the codes, and providing this information as a condition for receipt of the code (or reward associated with the code). For example, a method objective associated with a virtual object at one of the tagged locations can require a player to take a photograph of a particular landmark, art object, store front, or other feature located in the real world at a location corresponding to the location of a virtual object. In return for completing the game objective, the code is downloaded to the player's mobile device.

An exemplary game feature indirectly linked with data collection activity can include placing virtual objects at particular locations in the real world so that actions players take to interact with the virtual objects indirectly reveal information about the real world. For instance, a virtual game object can be located at a location corresponding to a park, hiking area, or other locale. By tracking player movements to navigate to the virtual object, the game system can also track corresponding movements in the real world that provide an indication of the location of traversable paths to the area.

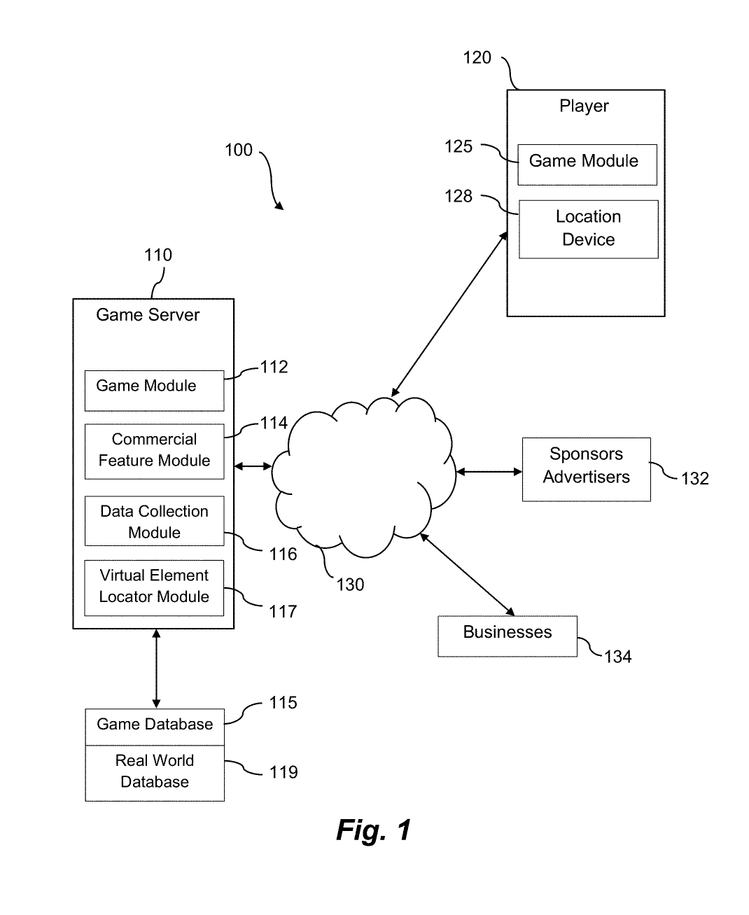

FIG. 1 illustrates an exemplary computer-implemented location-based gaming system and method 100 configured in accordance with an embodiment of the present disclosure. The location-based gaming system and method 100 provides for the interaction of one or a plurality of lottery game players in a real world environment augmented with virtual game objects. In particular, the players are directed to various geographic locations in the real world where virtual reality objects are introduced into the player's travel path. The system 100 can track the player's position in the real world and direct placement of the virtual objects accordingly.

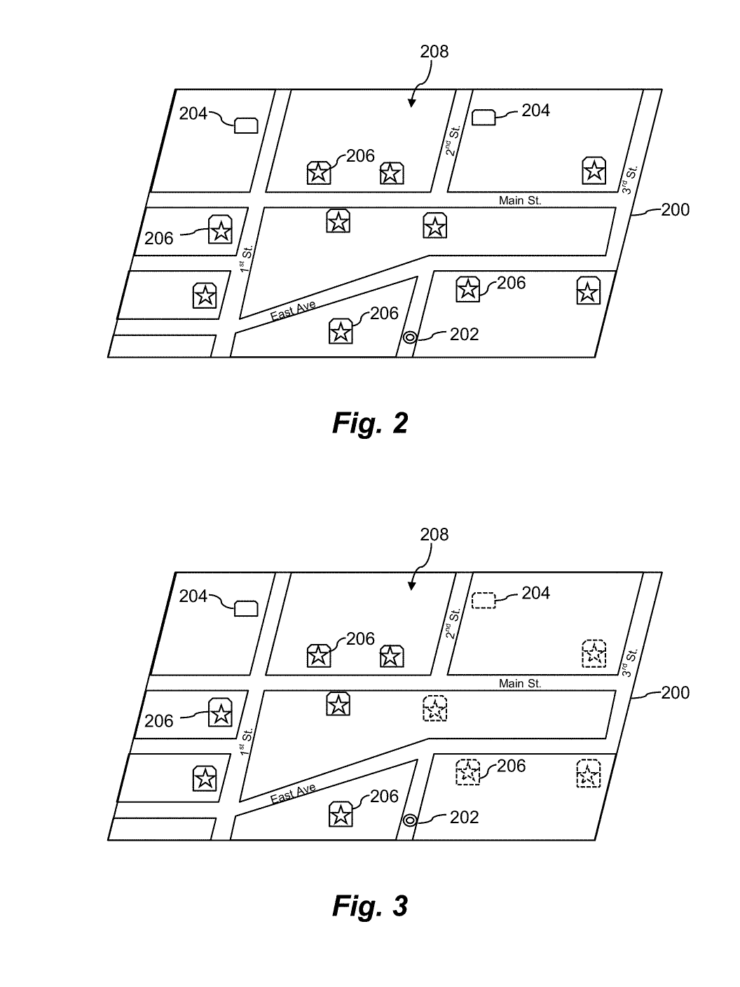

FIG. 2 depicts a conceptual diagram of a real world 200 defined by a geographic area 208 associated with a town, neighborhood, city, campus, locale, a country, continent, the entire globe, or other geographic area. A player's actual geographic location 202 in the geographic area 208 is noted. As the player 202 moves about in the geographic area 208, the coordinates of the geographic area may change accordingly. For example, the geographic area 208 can be defined as a two square mile area around the player's location 202. A positioning system associated with the player's mobile device (e.g. a GPS system) can be used to track a player's position as the player navigates the range of geographic coordinates in the real world.

Aspects of the method involve the player travelling to a retail establishment 204 within the geographic area 208. The location 204 is an authorized lottery ticket distribution establishment and may be, for example, a convenience store, a gas station, a bar or pub, a retail stores, and the like. The type of locations 204 can vary widely within the scope and spirit of the invention.

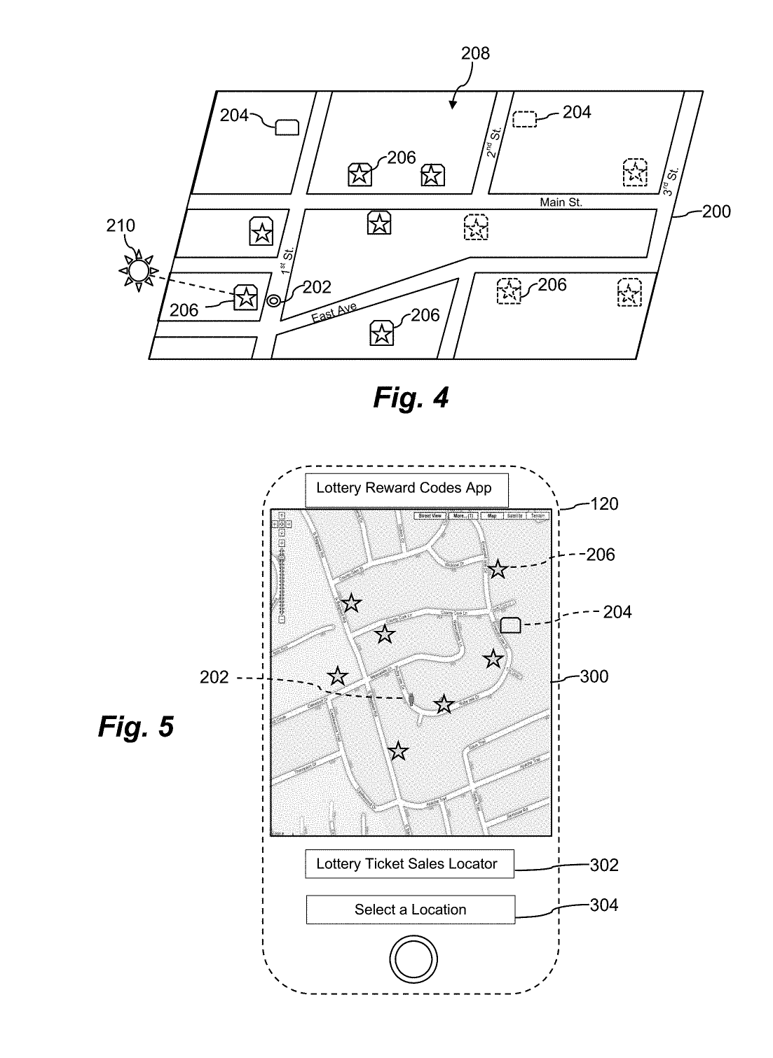

Referring to FIG. 4, by means of a software application that has been downloaded and is running on a mobile device 120 of the player, location of one or more of the retail establishments 204 where the player can purchase a lottery ticket is provided to the player, for example as locations pinned or otherwise identified or overlaid on a map displayed on the device screen 300.

Still referring to FIGS. 2 and 5, via the application on the player's mobile device 120, at least one geographic location 206 that lies between the player's actual location 202 and one of the retail establishments 204 is “tagged” (e.g. identified/labeled) on the map. As discussed further below, each of these locations 206 has a code associated therewith, wherein the code grants a value (e.g. an award or prize) to the player. The type of locations 206 can vary. For example, the locations 206 may be well-known landmarks or buildings, parks, or generally any publically accessible location. As discussed above, the locations 206 may be commercial establishments that have a commercial activity linked to the lottery game. For example, the locations 206 may be sponsor establishments that pay a fee to be one of the tagged locations 206, which will increase patron traffic to the particular location 206.

FIG. 2 depicts multiple retail establishments 204 identified within a predefined distance of the player's actual location 202. In this embodiment, the player may then freely choose which of the establishments 204 they wish to visit to purchase a lottery ticket. Referring to FIG. 5, prompts 302 and 304 may be enabled on the mobile device 120 that allow the player to make their selection of a particular establishment, wherein the selected establishment 204 and the player's actual location 202 are displayed on the mobile device screen 300. The multiple tagged locations 206 depicted in FIG. 2 may also be displayed on the screen map, as illustrated in FIG. 5. All of the tagged locations 206 may be common to all of the retail establishments 204 so that the player can acquire a code from any one or more of the tagged locations 206 regardless of the particular retail establishment 204 they choose to visit.

In an alternate embodiment conceptually depicted in FIG. 3, the tagged locations 206 may be associated with only specific ones of the retail establishments 204. In other words, each establishment may have its own respective set of associated locations 206 (wherein some of the locations 206 may be shared). This embodiment may be desirable for driving more patrons to remote (or otherwise less-frequented) retail establishments 204 by, for example, providing more valuable or an increased number of codes for these less-frequented locations 204. Upon the player selecting a particular one of the retail establishments 204, the tagged locations 206 that are not associated with the selected retail establishment 24 may be removed from the screen map on the player's mobile device, as depicted by the locations 206 shown in dashed lines in FIG. 3.

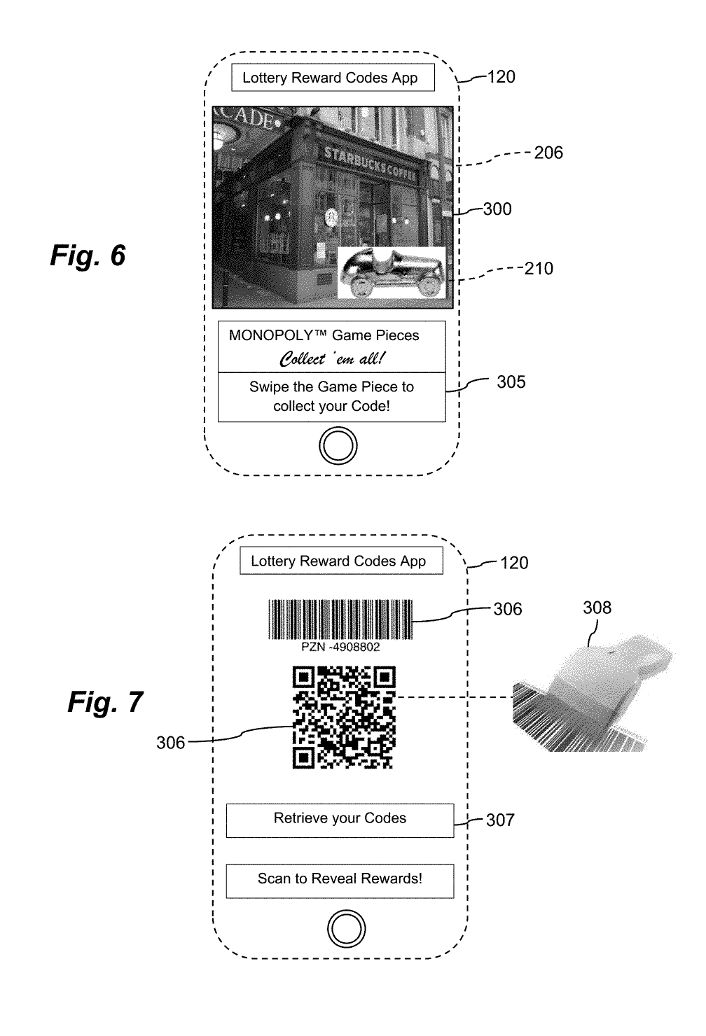

FIG. 4 conceptually depicts the player moving in the real world to one of the tagged locations 206. Once the player is within a defined distance from the location 206, the game server 110, via the application running on the mobile device 120, overlays a virtual objet 210 on an actual screen image of the location on the player's mobile device 120. For example, referring to FIG. 6, the location 206 is a coffee shop that is viewed by the mobile device's camera such that a real-time image of the coffee shop is displayed on the screen 300. An augmented reality virtual object 210 is overlaid on the screen image so as to appear to be present at the location 206. At this point, the player is provided with prompts 305 to interact with the virtual object 210 in some manner, for example by swiping the object 210 on the screen. It should be appreciated that the type of interaction can vary widely within the scope and spirit of the invention. The manner in which the player interacts with the virtual objects 210 can vary depending on the overall game theme. In certain embodiments, a game objective can require players to “capture” or otherwise acquire virtual objects 210, such as by taking a photograph and/or verifying, obtaining, or capturing other information about the location 206 associated with the virtual object 210. The player may need to take an action on their mobile device in order to acquire the virtual object 210, such as a screen swipe action or button activation to control a virtual weapon or tool used to acquire the virtual object 210.

The player's interaction with the virtual object 210 results in a code 306 being transmitted by the game server 110 and stored on the player's mobile device. The codes 306 may be downloaded to the player's mobile device in any suitable scannable format, such as a barcode, Q-code, alpha-numeric code, or the like. Prompts may be provided for the player to verify that such code 306 has been downloaded to the device 120 and is saved in a library.

As discussed, the code 306 has a value associated therewith, which may vary widely within the scope and spirit of the invention. For example, the value of the code 306 may be a discount or credit for goods or services at the particular retail establishment 204 where the value of the code 306 is revealed. In another embodiment, the code value may be a discount or credit for goods or services from a different unrelated retail establishment 132, 134 (FIG. 1), such as a restaurant, department store, service provider, and so forth (which includes Internet establishments). In still another embodiment, the value of the code 306 may be an enhancement to a prize award of a lottery ticket purchased at the retail establishment. For example, the code 306 may grant the player a multiplier value for any prize award from a lottery ticket.

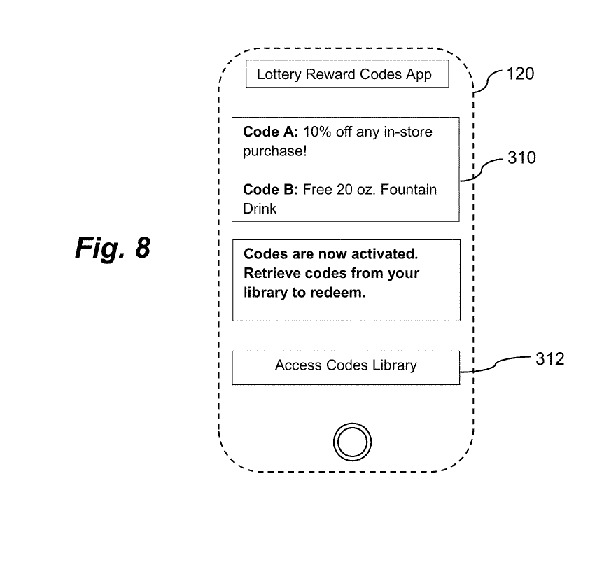

Referring to FIGS. 7 and 8, once the player has reached the retail establishment 204, they can retrieve the stored code 306 from the mobile device 120 (as prompted by instruction 307), wherein the code 306 is scanned and read by a conventional scanner 308. The code 306 is transmitted to the game server 110, and is activated by the game server 110. At this point, the player may redeem or otherwise use the code 306 at the retail establishment 204 or other business establishment. In this regard, the codes 306 may function as electronic coupons at the retail establishment or other business establishment. Depending on the value and nature of the award associated with the codes 306, the lottery authority may eventually reconcile the value of the coupon with the retail establishment 204 or other business establishment.

In a particular embodiment of the method, the value of the code is not made known to the player when the code 306 is downloaded to the player's mobile device, but is revealed to the player at the retail establishment 204 when the code is scanned, as depicted as reveal 310 in FIG. 8. Additionally, the method may require that the value of the code is only provided if the player actually purchases a lottery ticket at the retail establishment 204. In this embodiment, the value of the code 306 may be revealed to the player before they purchase the ticket so as to incentivize the purchase. In another embodiment, the value of the code may not be revealed until after the player purchases the ticket.

The lottery authority responsible for providing the lottery game may implement individual player accounts that can be accessed by the players via their mobile device 120. Once activated, the codes 306 may be recorded and accumulate in the player's respective account for later retrieval 312 and use by the player. The activated codes 306 may also be stored in a local library on the player's mobile device 120.

Referring back FIG. 1, the system 100 can include the lottery provider server architecture, where the game server 110 communicates with one or more players (mobile devices) 120 over a network 130. Although one player device 120 is illustrated, it should be understood that any number of players 120 can be connected to the game server 110 over the network 130. The server 110 can host a universal gaming module 112 that controls aspects of the location-based game components for all players 120 and receives and processes each player's input in the location based game. On the player-side, each mobile device 120 can include a gaming module 125 that operates as a gaming application so as to provide the player with an interface to the system 100. The game server 110 transmits game data over the network 130 to the mobile device 120 for use by the gaming module 125 to provide local versions of the game to players at locations remote from the game server 110. The server 110 can include a network interface for providing communications over the network 130. A network interface can include any suitable components for interfacing with one more networks, including for example, transmitters, receivers, ports, controllers, antennas, or other suitable components.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM hard disk or optical or magnetic media.

The game server 110 can be any computing device and can include one or more processors and one or more computer-readable media. The computer-readable media can store instructions which cause the processor to perform operations.

The game server 110 can include or can be in communication with a game database 115. The game database 115 stores game data used in the location-based game to be provided to the players 120 over the network 130. The game data can include: data associated with players of the location-based game (e.g. player information, player experience level, player currency, current player positions in the virtual world/real world, player energy level, player preferences, team information, faction information, etc.); data associated with game objectives (e.g. data associated with current game objectives, status of game objectives, past game objectives, future game objectives, desired game objectives, etc.); data associated virtual objects in the real world (e.g. positions of virtual objects, types of virtual objects, game objectives associated with virtual objects; corresponding actual world position information for virtual objects; behavior of virtual objects, relevance of virtual objects etc.); data associated with real world objects, landmarks, positions linked to virtual world objects (e.g. location of real world objects/landmarks, description of real world objects/landmarks, relevance of virtual objects linked to real world objects, etc.); data associated with player actions/input (e.g. current player positions, past player positions, player moves, player input, player queries, player communications, etc.); and any other data used, related to, or obtained during implementation of the location-based AR lottery game. The game data stored in the game database 115 can be populated either offline or in real time by system administrators and/or by data received from users/players of the system 100, such as from one or more player mobile devices 120 over the network 130.

The game server 110 can be configured to receive requests for game data from the player mobile devices and to respond to those requests via the network 130. For instance, the game server 110 can encode game data in one or more data files and provide the data files to the device 120. In addition, the game server 110 can be configured to receive game data (e.g. player positions, player actions, player input, etc.) from the devices 120 via the network 130. For instance, the devices 120 can be configured to periodically send player input and other updates to the game server 110, which the game server 110 uses to update game data in the game database 115 to reflect any and all changed conditions for the game.

As depicted, the game server 110 can include a universal game module 112. The universal game module 112 hosts the location-based game for all players and acts as the authoritative source for the current status of the location-based game for all players. The universal game module 112 receives game data from player devices 120 (e.g. player input, player position, player actions, landmark information, etc.) and incorporates the game data received into the overall location-based game for all players of the location-based game. The universal game module 112 can also manage the delivery of game data to the player devices over the network 130.

The game server 110 can further include a commercial feature module 114 that can be separate from or a part of the universal game module 112. The commercial game feature module 114 can manage the inclusion of various game features that are linked with a commercial activity in the real world. For instance, the commercial game feature module 114 can receive requests from sponsors/advertisers 132, businesses 134, or other entities over network 130 (via a network interface) to include game features linked with commercial activity in the real world game. The commercial game feature module 114 can then arrange for the inclusion of these game features in the parallel reality game. Examples of such commercial features include the purchase of merchandise from a sponsor or in a retail location at a discount, or to receive bonus points in a secondary game, or any activity that incentivizes players to purchase goods from a particular sponsor to visit a particular location.

The game server 110 can further include a data collection module 116 that can be separate from or a part of the universal game module 112. The data collection module 116 can manage the inclusion of various game features within the real world game that are linked with a data collection activity in the real world. For instance, the data collection module 116 can modify game data stored in the game database 115 to include game features linked with data collection activity in the real world game. The data collection module 116 can also analyze data collected by players pursuant to the data collection activity and provide the data for access by various platforms.

Other modules can be used with the game server 110. Any number of modules can be programmed or otherwise configured to carry out the server-side functionality described herein. In addition, the various components on the server-side can be rearranged. For instance, the game database 115 can be integrated into the game server 110. Other configurations will be apparent in light of this disclosure and the present disclosure is not intended to be limited to any particular configuration.

The player's mobile device 120 can be any portable computing device that can be used by a player to interface with the gaming system 100. For instance, the device 120 can be a wireless device, a personal digital assistant (PDA), portable gaming device, cellular phone, smart phone, tablet, navigation system, handheld GPS system, wearable computing device, a display having one or more processors, or other such device. In short, the player mobile device 120 can be any computer-device or system that can execute a gaming module 125 to allow a player to interact with the game system 100.

The player mobile device 120 can include one or more processors and one or more computer-readable media. The computer-readable media can store instructions which cause the processor to perform operations. The device 120 can include various input/output devices for providing and receiving information from a player, such as a display screen, touch screen, touch pad, data entry keys, speakers, and/or a microphone suitable for voice recognition. The device 120 can further include a network interface for providing communications over the network 130. A network interface can include any suitable components for interfacing with one more networks, including for example, transmitters, receivers, ports, controllers, antennas, or other suitable components.

The gaming module 125 executed by the player mobile device 120 provides an interface between a player and the location-based aspects implemented by the game system 100. The gaming module 125 can present a user interface on a display device associated with the mobile device 120 that displays a real world environment associated with the game and a virtual object(s) overlay. The interface allows the player to interact with the overlaid virtual objects to perform various game objectives. The gaming module 125 can access game data received from the game server 110 to provide an accurate representation of the game to the user. The gaming module 125 can receive and process player input and provide updates to the game server 110 over the network 130.

As mentioned, the gaming system 100 is for a location-based game, and the player mobile device 120 is preferably a portable computing device, such as a smartphone or other portable device, that can be easily carried or otherwise transported with a player. A player can interact with the virtual objects simply by carrying or transporting the mobile device 120 to locations in the real world where the virtual objects are enabled. In this regard, the player mobile device 120 can include a location device 128 that monitors the position of a player during game play. The location device 128 can be any device or circuitry for monitoring the position of the mobile device 120. For example, the location device 128 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position.

As the player moves around with the mobile device 120 in the real world, the location device 128 tracks the position of the player and provides the player position information to the gaming module 125, which continuously or periodically updates the player's actual position in the real world. Based on this real world position, the gaming module 112 identifies real world locations within a defined proximity where the virtual objects are located and transmits such locations to the game module 125, which displays or otherwise notifies the player of such locations, for example by displaying the locations on a real world map provided on the mobile device's screen. In certain embodiments, location information associated with a player is utilized only if permission is granted after the player has been notified that location information of the player is to be accessed and how the location information is to be utilized in the context of the game. In addition, any location information associated with players will be stored and maintained in a manner to protect player privacy.

The network 130 can be any type of communications network, such as a local area network (e.g. intranet), wide area network (e.g. Internet), or some combination thereof. The network can also include a direct connection between a player mobile device 120 and the game server 110. In general, communication between the game server 110 and player mobile device 120 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

Referring again to FIGS. 1 and 2, for locating the virtual objects 210 in the real world geography 208, the game server 110 accesses data associated with one or more real world conditions. For instance, a virtual object locator module 117 implemented by the game server 110 can access data associated with one or more real world conditions stored in the game database 115 (which may include a real world condition database 119). Alternatively, the locator module 114 can access one or more different data sources providing real world condition data, such as a third party data service or other data source. Exemplary data associated with one or more real world conditions accessed by the game server 110 can include the aggregate locations of individuals (e.g. players) in the real world; local time data; local data providing locations of cultural value, recreational value, historical value, commercial value, or other value; map data providing the locations of roads, highways, and waterways, public property, private property, and other information; current and past locations of individual players; hazard data; weather data; event calendar data; and other suitable data.

The game server 110 analyzes the data associated with the one or more real world conditions to determine a location for placement of a virtual object 210 at a location 206 based on the data associated with the one or more real world conditions. The locator module 114 can determine locations for placement of any type of virtual object 210 used in the AR game, such as a virtual item, virtual energy, or other virtual object 210 that forms a part of the AR game aspects. Exemplary analysis techniques for analyzing data associated with real world conditions to determine a location for placement of virtual objects in the virtual world will be discussed in detail below.

The game server 110 can modify game data stored in, for instance, the game database 115 and/or transmitted to player mobile devices 120 over the network 130 to locate one or more virtual objects 210 at locations 206 determined based on the data associated with real world conditions. The game server 110 can send files encoded with game data to the mobile devices 120 over the network 130, wherein the game data can include data locating virtual objects 206 in the player's real world.

The player mobile device 120 accesses the game data transmitted by the game server 110 and then presents the virtual objects 210, for example by displaying a real world picture of the player's location 202 acquired by the device's camera on a display screen 300 with one or more of the virtual objects 210 overlaid on the real world picture. Other suitable interfaces can be provided to present the virtual objects 210 to the player, such as audio, vibratory, or other interfaces so that a player can interact with the virtual objects 210 without having to look at the display screen 300 of the device 120.

The player mobile device 120 receives data indicative of player actions in the AR game, such as data indicative of the player's movement as determined by the location device 128, and provides this data to the game server 110. The game server receives the data and updates the game data for the AR game based on the received data. For example, the received data may indicate that the player has moved a predefined distance away from the location 206, wherein the virtual object 210 is disabled or removed from the screen until the player returns or moves on to another location 206.

As discussed, the virtual objects 210 are located at locations 206 corresponding to the predicted path of travel of the player so that the game encourages patron interaction with such locations 206. For example, data associated with current and past player position for a particular player is accessed by the locator module 114 from the game database 115 which stores position information associated with players of the AR game. The locator module 114 can access map data providing the locations of traversable paths proximate the player's current position, and can analyze current player position and direction, past player position and direction, the locations of traversable paths proximate the players and predict a future path for the player. The locator module 114 can then locate a virtual object 210 at one or more of the locations 206 along the predicted player path.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A method for introducing augmented reality aspects to a lottery game that encourage players to visit retail establishments that sell lottery tickets, the method comprising:
configuring a game server for communication with a player's mobile device to implement the augmented reality lottery game, the game server receiving real-world location data from the mobile device;
via an application running on the mobile device, identifying a retail establishment location where the player can purchase a lottery ticket;
via the application running on the mobile device, tagging at least one geographic location between the player's actual location and the retail establishment;
upon the player reaching the tagged location, the game server enabling an overlay of a virtual objet on a screen image of the geographic location on the mobile device;
the application running on the player's mobile device providing for the player to interact with the virtual object, wherein the interaction causes a code to be downloaded to the mobile device, the code associated with a value; and
at the retail establishment, activating the value of the code for the player.

2. The method according to claim 1, wherein the value of the code is not made known to the player when the code is downloaded and is revealed to the player at the retail establishment.

3. The method according to claim 1, wherein the value of the code is revealed to the player when the player purchases a lottery ticket at the retail establishment.

4. The method according to claim 1, wherein the value of the code is a discount or credit for goods or services at the retail establishment.

5. The method according to claim 1, wherein the value of the code is a discount or credit for goods or services at a different retail or commercial establishment.

6. The method according to claim 1, wherein the value of the code is credited to an account maintained by a lottery authority for the player.

7. The method according to claim 1, wherein the value of the code is an enhancement to a prize award of a lottery ticket purchased at the retail establishment.

8. The method according to claim 1, wherein multiple ones the retail establishments are identified to the player within a predefined distance of the player's actual location.

9. The method according to claim 8, wherein the retail establishments and the player's actual location are presented in a map provided on the mobile device, wherein multiple ones of the tagged locations are also provided on the map.

10. The method according to claim 9, wherein the tagged locations are associated with specific ones of the retail establishments, and upon the player selecting a particular one of the retail establishments, the tagged locations that are not associated with the selected retail establishment are removed from the map.

11. The method according to claim 1, wherein the code is scannable code, the method further providing for the player to have the code scanned directly from their mobile device at the retail establishment to reveal the value of the code.
